(19) United States
(12) Patent Application Publication
(10) Pub. No.: US 2020/0381710 A1
(43) Pub. Date: Dec. 3, 2020

(54) SURFACE MODIFICATION AND ENGINEERING OF SILICON-CONTAINING ELECTRODES

(71) Applicant: Enevate Corporation, Irvine, CA (US)

(72) Inventors: Liwen Ji, San Diego, CA (US); Benjamin Yong Park, Mission Viejo, CA (US)

(21) Appl. No.: 16/430,302

(22) Filed: Jun. 3, 2019

(51) Int. Cl. H01M 4/1395; H01M 4/134; H01M 4/38; H01M 4/1391; H01M 4/131

(52) U.S. Cl. CPC H01M 4/1395; H01M 4/134; H01M 2004/027; H01M 4/1391; H01M 4/131; H01M 4/386

(57) ABSTRACT

The present application describes the use of a solid electrolyte interphase (SEI) enhancement precursor and/or an SEI enhancement compound to coat an electrode material and create an artificial SEI layer. These modifications may increase surface passivation of the electrodes, SEI robustness, and structural stability of silicon-containing electrodes.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present application relates generally to silicon particles. In particular, the present application relates to silicon particles and materials including silicon particles for use in battery electrodes.

### Description of the Related Art

A lithium-ion (Li-ion) battery typically includes a separator and/or electrolyte between an anode and a cathode. In one class of batteries, the separator, cathode and anode materials are individually formed into sheets or films. Sheets of the cathode, separator and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

Li-ion batteries having carbonaceous anodes and Li transition metal oxide cathodes are far behind the current requirements for widespread applications. Increasing demand for high energy density, long cycle life, and low-cost Li-ion batteries in critical applications, such as electrical vehicles and portable electronic or medical devices, have stimulated extensive research interest in developing novel electrode materials with enhanced performance for Li-ion batteries. Based on a reversible alloying-dealloying reaction mechanism at room temperature, silicon (Si) stores 10 times more Li (Li₁₅Si₄: 3579 mAh/g, 8343 Ah/L) than the current commercial graphite anode (LiC₆: 372 mAh/g, 804 Ah/L) at room temperature. With the same cathode chemistry, the replacement of graphite with Si may enable significant gains in the capacity. In addition to the natural abundance and environmental friendliness of Si, its low operating potential of 0.4 V (on average, vs. Li/Li⁺) can avoid adverse Li plating and enable a high-energy Li-ion full cell. However, a major disadvantage associated with Si anodes is the large volumetric changes during lithiation. This undesirable volume expansion causes Si fracturing that results in electrical isolation of the particles, accumulation of solid electrolyte interphase (SEI) layers, electrode thickness changes, and fast degradation in cycling performance.

Various strategies have been introduced to solve these problems, which have had limited success. Improvements in Li storage capacity and cycling properties in coin cell levels have been demonstrated by using nanostructured Si anodes, however the suppression of pulverization of bulk Si particles and long-term cycling stability at high Si loading conditions have not yet been sufficiently demonstrated.

Much of the existing work on Si anodes does not meet the requirements for commercial applications because of their unsatisfactory performances and the serious challenges associated with cost and scale-up. Recently, many battery experts and companies have focused on commercializing Si anode-based Li-ion full cells through designing multi-dimensional anode structures with uniform size distributions. However, in most cases only small amounts of Si or Si alloy may be used because of the generally inferior cycle life of Si compared to graphite.

### SUMMARY

In certain implementations, a method of preparing an electrode is provided. The method can include providing an electrode material comprising silicon and exposing the electrode material to a solution. The solution can comprise a solid electrolyte interphase (SEI) enhancement precursor of an SEI enhancement compound and/or the solution can comprise the SEI enhancement compound. The method can also include exposing the electrode material to acidic conditions and forming an artificial SEI layer comprising the SEI enhancement compound on the electrode material from the SEI enhancement precursor and/or the SEI enhancement compound.

In some implementations, the method can include forming the electrode material into the electrode. For example, the electrode can be an anode. In some instances, the electrode material can include the silicon as Si particles. The Si particles can have an average particle size between 1 μm and 50 μm. In some instances, the electrode can comprise Si dominant electrochemically active material. For example, the electrochemically active material can comprise the silicon at about 70% to about 100% by weight.

In some implementations, the electrode material can comprise the electrode. For example, the electrode can be an anode. In some instances, the electrode can include Si dominant electrochemically active material. For example, the electrochemically active material can comprise the silicon at about 70% to about 100% by weight.

In some methods, exposing the electrode material to the solution and exposing the electrode material to acidic conditions can occur concurrently by exposing the electrode material to the solution comprising the SEI enhancement precursor in acidic conditions. Alternatively, exposing the electrode material to the solution can comprise exposing the electrode material to the solution comprising the SEI enhancement precursor, and subsequently exposing the electrode material to acidic conditions. As another example, exposing the electrode material to the solution can comprise exposing the electrode material to the solution comprising the SEI enhancement precursor subsequent to exposing the electrode material to acidic conditions.

In some methods, exposing the electrode material to the solution and exposing the electrode material to acidic conditions can occur concurrently by exposing the electrode material to the solution comprising the SEI enhancement compound in acidic conditions. Alternatively, exposing the electrode material to the solution can comprise exposing the electrode material to the solution comprising the SEI enhancement compound, and subsequently exposing the electrode material to acidic conditions. As another example, exposing the electrode material to the solution can comprise exposing the electrode material to the solution comprising the SEI enhancement compound subsequent to exposing the electrode material to acidic conditions.

In some methods, the artificial SEI layer can comprise nanoparticles of the SEI enhancement compound on the electrode material. In some methods, the artificial SEI layer can comprise a film of the SEI enhancement compound on the electrode material.

In some methods, the SEI enhancement precursor can comprise a silicon oxide precursor, a metal oxide precursor, a metal nitride precursor, a metal oxynitride precursor, a metal phosphide precursor, or a combination thereof. For example, the silicon oxide precursor can comprise tetraethyl orthosilicate (TEOS), trimethoxysilane (TMOS), methyltriethoxysilane (MTES), or a combination thereof.

In some methods, the SEI enhancement compound can comprise a silicon oxide compound, a metal oxide compound, a metal nitride compound, a metal oxynitride compound, a metal phosphide compound, or a combination thereof. For example, the silicon oxide compound can comprise SiOₓ where 1≤x≤2. As another example, the metal oxide compound can comprise Al₂O₃, TiO₂, CuO, ZnO, SnO₂, Nb₂O₅, RuO₂, IrO₂, TiNb₂O₇, ZnₓFe_{y}O_{z}, M-LiₓO wherein M is a transition metal, or a combination thereof. As another example, the metal nitride compound can comprise TiN, Ni₃N, Ti₂N, NbN, Nb₄N₅, Mn₃N₂, Fe₂N, CoN, CrN, MoN, MoN₂, WN, Sb₃N, Zn₃N₂, Ge₃N₄, Ti₍₁₋ₓ₎NbₓN, SnNₓ, VN, or a combination thereof. As another example, the metal oxynitride compound can comprise MoOₓN_{y}, TiOₓN_{y}, N—MoO₃ₓ, or a combination thereof, wherein x≤1 for N—MoO₃ₓ. As another example, the metal phosphide compound can comprise TiP, NiP₄, NiP₃, NiP₂, Sn₄P₃, MnP, FeP, Cu₃P, or a combination thereof.

In some instances, the weight ratio of the SEI enhancement precursor to the electrode material can be about 1:1 to about 1:20. For example, the weight ratio of the SEI enhancement precursor to the electrode material can about 1:2.5 to about 1:15. As another example, the weight ratio of the SEI enhancement precursor to the electrode material can be about 1:5 to about 1:10. For example, the weight ratio of the SEI enhancement precursor to the electrode material can be about 1:5. As another example, the weight ratio of the SEI enhancement precursor to the electrode material can be about 1:10.

In various implementations, an electrochemical device is provided. The device can include a first electrode, a second electrode, and an electrolyte. The first electrode can include a silicon-dominant electrochemically active material and an artificial solid electrolyte interphase (SEI) layer comprising nanoparticles of an SEI enhancement compound.

In some instances, the electrochemically active material can comprise silicon at about 70% to about 100% by weight. The first electrode can comprise an anode, and the second electrode can comprise a cathode. The second electrode can comprise lithium.

In some devices, the SEI enhancement compound can comprise a silicon oxide compound, a metal oxide compound, a metal nitride compound, a metal oxynitride compound, a metal phosphide compound, or a combination thereof. For example, the silicon oxide compound can comprise SiOₓ where 1≤x≤2. As another example, the metal oxide compound can comprise Al₂O₃, TiO₂, CuO, ZnO, SnO₂, Nb₂O₅, RuO₂, IrO₂, TiNb₂O₇, ZnₓFe_{y}O_{z}, M-LiₓO wherein M is a transition metal, or a combination thereof. As another example, the metal nitride compound can comprise TiN, Ni₃N, Ti₂N, NbN, Nb₄N, Mn₃N₂, Fe₂N, CoN, CrN, MoN, MoN₂, WN, Sb₃N, Zn₃N₂, Ge₃N₄, Ti₍₁₋ₓ₎NbₓN, SnNₓ, VN, or a combination thereof. As another example, the metal oxynitride compound comprises MoOₓN_{y}, TiOₓN_{y}, N—MoO₃ₓ, or a combination thereof, wherein x≤1 for N—MoO₃ₓ. As another example, the metal phosphide compound can comprise TiP, NiP₄, NiP₃, NiP₂, Sn₄P₃, MnP, FeP, Cu₃P, or a combination thereof.

In some devices, the electrolyte can comprise fluoroethylene carbonate (FEC), ethyl methyl carbonate (EMC), or a mixture thereof. For example, the electrolyte can comprise greater than or equal to about 10 wt % FEC, EMC, or a mixture thereof. As another example, the electrolyte can comprise about 30 wt % FEC and about 70 wt % EMC. In some instances, the electrolyte may or may not comprise ethylene carbonate (EC).

In some devices, the electrolyte can comprise LiPF₆. For example, the electrolyte can comprise the LiPF₆ at a concentration of about 1 M to about 1.2 M.

In some instances, the second electrode can comprise LiCoO₂. In some embodiments, the second electrode can comprise Nickel-Cobalt-Manganese (NCM), Nickel-Cobalt-Aluminum (NCA), or a combination thereof.

In some instances, the electrochemically active material can be a self-supported film. The electrochemical device can be a battery.

### BRIEF DESCRIPTION OF THE DRAWINGS

FIG. 1 depicts a method of coating a SiO₂ layer or SiO₂ nanoparticles on the surface of Si powder from a TEOS solution, and subsequently using the coated Si powders to prepare electrodes.

FIG. 2 depicts an example method of preparing an electrode in accordance with certain embodiments described herein.

FIG. 3A shows the charge capacity as a function of voltage of a battery in one embodiment compared to a control battery.

FIG. 3B shows the discharge capacity retention as a function of voltage of a battery in one embodiment compared to a control battery.

FIG. 4A shows the capacity as a function of cycles of a battery in one embodiment compared to a control battery.

FIG. 4B shows the capacity retention as a function of cycles of a battery in one embodiment compared to a control battery.

FIG. 5A shows the average resistance as a function of cycles after 10 s charge of a battery in one embodiment compared to a control battery.

FIG. 5B shows the average resistance as a function of cycles after 10 s discharge of a battery in one embodiment compared to a control battery.

FIG. 6A shows the average resistance as a function of cycles after 30 s charge of a battery in one embodiment compared to a control battery.

FIG. 6B shows the average resistance as a function of cycles after 30 s discharge of a battery in one embodiment compared to a control battery.

FIG. 7A shows the charge capacity as a function of voltage of a battery in another embodiment compared to a control battery.

FIG. 7B shows the discharge capacity retention as a function of voltage of a battery in another embodiment compared to a control battery.

FIG. 8A shows the capacity as a function of cycles of a battery in another embodiment compared to a control battery.

FIG. 8B shows the capacity retention as a function of cycles of a battery in another embodiment compared to a control battery.

FIG. 9A shows the average resistance as a function of cycles after 10 s charge of a battery in another embodiment compared to a control battery.

FIG. 9B shows the average resistance as a function of cycles after 10 s discharge of a battery in another embodiment compared to a control battery.

FIG. 10A shows the average resistance as a function of cycles after 30 s charge of a battery in another embodiment compared to a control battery.

FIG. 10B shows the average resistance as a function of cycles after 30 s discharge of a battery in another embodiment compared to a control battery.

FIG. 11 depicts a Si-dominant anode dip coated in a SiO₂ solution prepared from TEOS.

FIG. 12 depicts a Si-dominant anode dip coated in a TEOS alcohol solution, then subsequently a low pH aqueous solution was added to transfer soaked TEOS into SiO₂.

### DETAILED DESCRIPTION

This application describes certain embodiments of silicon material that may be used as electrochemically active material in electrodes (e.g., anodes and cathodes) in electrochemical cells. Silicon can be a potentially high energy per unit volume host material, such as for lithium ion batteries. For example, silicon has a high theoretical capacity and can increase the energy density of lithium ion batteries compared with lithium ion batteries using other active materials such as graphite. However, silicon can swell in excess of 300% upon lithium insertion. Accordingly, batteries with silicon anodes may exhibit more rapid capacity loss upon cycling compared with batteries with graphite anodes. The repeat expansion and contraction of silicon particles during charge and discharge can lead to mechanical failure of the anode during cycling. Mechanical failure can expose new surfaces of silicon which can react with the electrolyte, irreversibly incorporating Li-ions in the solid electrolyte interface/interphase (SEI), and leading to capacity loss. Certain embodiments described herein can include silicon material with a modified surface, leading to improved cycling performance. For example, some embodiments can provide an SEI with increased stability (e.g., a substantially stable SEI and/or a stable SEI in some instances) to improve the capacity retention and reduce (e.g., and/or prevent in some instances) fast fading.

Better cyclability can be expected when the mechanical stress induced by the large volume change of Si is eased and the reactions between Si and electrolyte are suppressed. Modifying the surface chemistry and passivating the Si electrode may help reduce and/or minimize the issues associated with Si. Through the surface modification and engineering of Si electrodes, the SEI layer may be controlled and improved (and/or optimized in some cases), further prolonging the cycle performance in Si-containing electrodes (e.g., Si-dominant electrodes).

To overcome the current obstacles associated with developing high-energy Li-ion full-cells with Si-based electrodes, the present application describes the use of an SEI enhancement precursor and/or an SEI enhancement compound to coat an electrode material, e.g., with an artificial SEI layer from the SEI enhancement precursor and/or the SEI enhancement compound. The surface properties of Si material (e.g., powders, particles, fibers, etc.) can be closely related to the SEI structure, electrode stability and electrochemical cycling of a Si-based electrode in Li-ion batteries. When first alloying with Li, the surface of Si typically undergoes chemical side-reactions with the electrolyte to form an SEI film. In this way, an artificial SEI layer (e.g., a film coating) may reduce and/or prevent further parasitic chemical reactions on the surface of Si and improve the reversibility of the Si electrodes. An artificial SEI film may help reduce and/or minimize volume expansion, increase the stability of and/or stabilize the surface of Si against electrical isolation following pulverization, and improve the electronic and ionic conductivities of Si electrodes during operation and cycling. For surface coatings, the characteristics of one or more artificial SEI layers may include: (i) optimized thickness with good electrically conductivity; (ii) mechanical toughness and robustness; and (iii) excellent ionic conductivity. In some instances, the thickness of the one or more layers can be from about 1 nm to about 20 nm (e.g., about 1 nm to about 15 nm, about 1 nm to about 10 nm, etc.).

Furthermore, the use of Si composites such as Si with a coating layer (e.g., an oxide layer) rather than pure Si as electrode materials for Li-ion batteries may lead to an improvement in the capacity retention because the coating layers could act as buffer layers for the large volume changes of Si during the charging-discharging process. In some designs, extra carbon shells may be formed. For example, one or more carbon sources (e.g., graphite, carbon black, etc.) can be added during the Si electrode preparation process. As another example, one or more carbon precursors (e.g., polymers) can be added and transformed to carbon during a carbonization or pyrolysis process. These extra layers may help further enhance the electrical conductivity. These multifunctional coating layers may favor the formation of a more stable SEI layer on the Si electrode surface, reduce and/or minimize interface impedance, and further buffer the volume changes during lithiation/delithiation processes. In addition, the coating layers may help dissipate strain energy via atomic rearrangement of overcoordinated atoms (e.g., an effect notable when an oxide coating is highly coordinated) while also increasing the activation volume of the silicon core, decreasing and/or preventing localized deformation from occurring. Generally, by having mechanically robust coatings which can accommodate volume expansion, increases in toughness and ductility are expected, which can improve long-term stability of Si-containing electrodes, e.g., in Li-ion batteries.

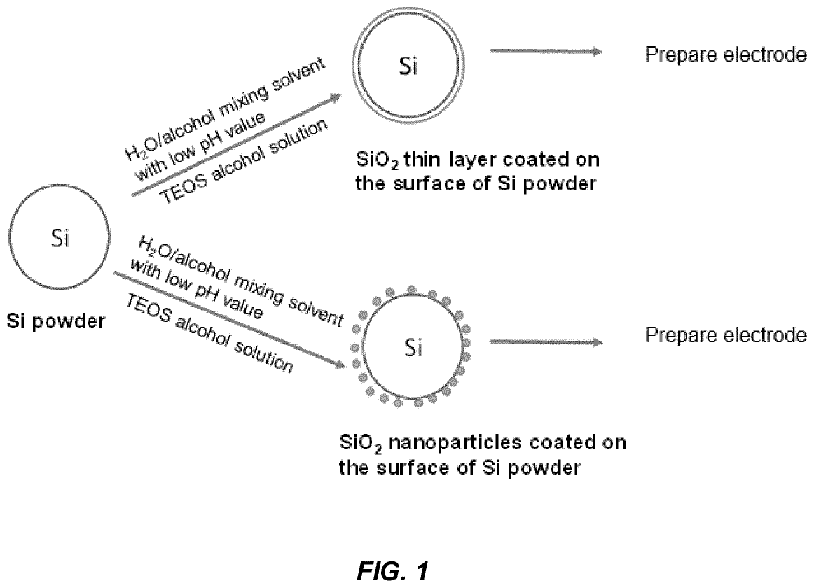

FIG. 1 discloses one embodiment in which tetraethyl orthosilicate (TEOS), e.g., in an alcohol solution, is used as a precursor to coat a layer of SiO₂ on the surface of Si powders utilizing a low pH suspension (e.g., an H₂O/alcohol mixing solvent with low pH value) to prepare a SiO₂ coated Si-containing electrode. FIG. 1 shows coating (e.g., direct coating in some instances) of a SiO₂ thin layer or SiO₂ nanoparticles (prepared from TEOS) on the surface of Si powder. Then the coated Si powders can be used to prepare electrodes.

In some implementations, the Si coated with SiO₂ can be mixed with binder in a solvent and coated onto a current collector. For example, the Si coated with SiO₂ may be used as the active material in powder form. The binder and current collector may be any of those known in the art or yet to be developed. For example, the current collector may be a copper or nickel foil. In some instances, conductive particles (e.g., carbon) may be added.

In some implementations, the coated Si powders can be used to prepare film-based electrodes. For example, some composite material films can be monolithic, self-supporting structures using pyrolyzed polymer, e.g., as described in U.S. patent application Ser. No. 13/008,800 (U.S. Pat. No. 9,178,208), entitled “Composite Materials for Electrochemical Storage;” U.S. patent application Ser. No. 13/601,976, filed Aug. 31, 2012, and published on Jun. 19, 2014 as U.S. Patent Application Publication No. 2014/0170498, entitled “Silicon Particles for Battery Electrodes;” or U.S. patent application Ser. No. 13/799,405 (U.S. Pat. No. 9,553,303), entitled “Silicon Particles for Battery Electrodes,” each of which is incorporated by reference herein. In some embodiments, the self-supported composite material film can be used as an electrode (e.g., without a current collector).

Some composite material films may be provided on a current collector to form an electrode. In some embodiments, the composite material film can be attached to a current collector using an attachment substance. The attachment substance and current collector may be any of those known in the art or yet to be developed. For example, some composite material films can be provided on a current collector as described in U.S. patent application Ser. No. 13/333,864 (U.S. Pat. No. 9,397,338), entitled “Electrodes, Electrochemical Cells, and Methods of Forming Electrodes and Electrochemical Cells;” or U.S. patent application Ser. No. 13/796,922 (U.S. Pat. No. 9,583,757), entitled “Electrodes, Electrochemical Cells, and Methods of Forming Electrodes and Electrochemical Cells, each of which is incorporated by reference herein. Some composite material films may be formed on a current collector, e.g., as described in U.S. patent application Ser. No. 15/471,860, filed Mar. 28, 2017, and published on Oct. 4, 2018 as U.S. Patent Application Publication No. 2018/0287129, entitled “Methods of Forming Carbon-Silicon Composite Material on a Current Collector,” which is incorporated by reference herein.

Coating an SiO₂ shell on the outside of the Si powder can offer a static surface for the formation of a thin and stable SEI layer, which can help preserve the electrode from irreversible reaction with the electrolyte. Without being bound to theory, it is believed that when Li enters the oxide layer during the initial charge, SiO₂ may be transformed into amorphous Li₄SiO₄ which acts as a migration path for the Li-ions. In this way, the LiSiO₄ may surround Si powders and the extent of their transformation into fine particles may be reduced in the following cycling. This may lead to the improvement of capacity retention.

In various embodiments, at least one artificial SiO₂ (or SiOₓ where 1≤x≤2) layer can be coated on the Si powder. The layer can be about 1 nm to about 20 nm thick (e.g., about 1 nm to about 15 nm, about 1 nm to about 10 nm, about 3 nm to about 20 nm, about 3 nm to about 15 nm, about 3 nm to about 10 nm, about 4 nm to about 20 nm, about 4 nm to about 15 nm, about 4 nm to about 10 nm, about 5 nm to about 20 nm, about 5 nm to about 15 nm, about 5 nm to about 10 nm, etc.). The artificial layer can be SiO₂ (or SiOₓ where 1≤x≤2) nanoparticles adhered (e.g., but not covalently bonded in some instances) to the Si powders. In some embodiments, the artificial layer can be formed over a native silicon oxide layer (e.g., comprising Si—OH). The native oxide layer (e.g., about 2 nm thick) may be continuous and not mechanically robust enough to accommodate volume expansion. Without being bound to theory, an additional layer (e.g., an artificial layer) can provide more mechanical robustness and/or coverage of the Si powder surface.

Although it is hypothesized that SiO₂ is created when TEOS reacts with the acidic solution/suspension and coats the Si powder, the SiO₂ may be otherwise simply mixed in with the Si powders. In some embodiments, instead of being particulate in form, the artificial layer may form as a layer (e.g., a continuous layer in some instances) on the surface of the Si due to the surface of the Si acting as a precipitating surface/seed layer.

As described herein, the coating of a SiO₂ layer on the surface of Si powders through chemical reactions in acidic conditions may act as an artificial defensive matrix that may provide more stable or substantially stable LiₓSi cycling processes. In some instances, the electrode comprising Si may be coated with the SiO₂ layer. Coating of the Si powder or electrode may be performed by numerous methods, for example: (i) TEOS may be used to prepare SiO₂ in acidic conditions to coat on the surface of micron-sized Si powders (e.g., having an average particle size of about 1 μm to about 50 μm), wherein the SiO₂ coated Si powders may be used to prepare Si-containing electrodes (e.g., Si-dominant electrodes); (ii) TEOS may be added to water to obtain SiO₂ suspension, then Si-containing electrode coupons may be dipped; and (iii) Si-containing electrodes may be dipped in a TEOS solution first, then a low pH aqueous solution may be added to the electrode to convert the soaked TEOS into SiO₂.

Further electrochemical device advantages of electrodes formed with the artificial SEI layer described may include increased cycle life, increased energy density, increased safety, and decreased electrolyte consumption.

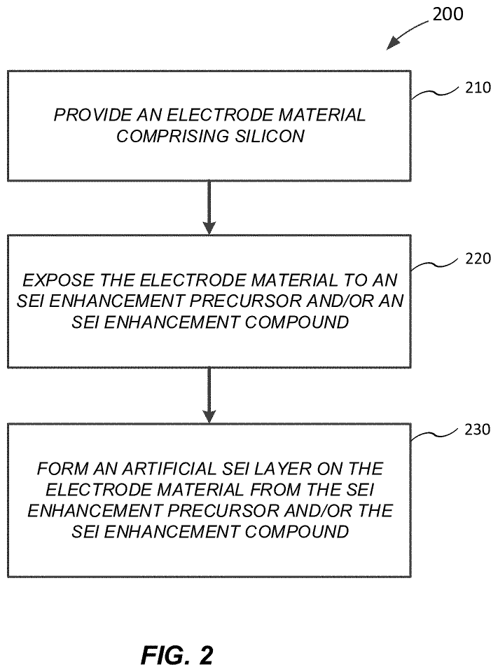

In some embodiments, a method of preparing an electrode is described. FIG. 2 shows an example method. The method 200 can include providing an electrode material comprising silicon, as shown in block 210, and exposing the electrode material to an SEI enhancement precursor and/or an SEI enhancement compound, as shown in block 220. The method 200 can also include forming an artificial SEI layer on the electrode material from the SEI enhancement precursor and/or the SEI enhancement compound, as shown in block 230.

With respect to block 210, the electrode material can comprise silicon. In certain embodiments, the silicon material can be at least partially crystalline, substantially crystalline, and/or fully crystalline. Furthermore, the silicon material may be substantially pure silicon or may be a silicon alloy. In one embodiment, the silicon alloy includes silicon as the primary constituent along with one or more other elements. For example, these elements may include aluminum (Al), iron (Fe), copper (Cu), oxygen (O), or carbon (C).

In some embodiments, the electrode material can comprise silicon powders/particles. For example, the particle size (e.g., diameter or a largest dimension of the silicon particles) can be less than about 50 μm, less than about 40 μm, less than about 30 μm, less than about 20 μm, less than about 10 μm, less than about 1 μm, between about 10 nm and about 50 μm, between about 10 nm and about 40 μm, between about 10 nm and about 30 μm, between about 10 nm and about 20 μm, between about 0.1 μm and about 50 μm, between about 0.1 μm and about 40 μm, between about 0.1 μm and about 30 μm, between about 0.1 μm and about 20 μm, between about 0.5 μm and about 50 μm, between about 0.5 μm and about 40 μm, between about 0.5 μm and about 30 μm, between about 0.5 μm and about 20 μm, between about 1 μm and about 50 μm, between about 1 μm and about 40 μm, between about 1 μm and about 30 μm, between about 1 μm and about 20 μm, between about 1 μm and about 15 μm, between about 1 μm and about 10 μm, between about 10 nm and about 10 μm, between about 10 nm and about 1 μm, less than about 500 nm, less than about 100 nm, about 100 nm, etc. All, substantially all, or at least some of the silicon particles may comprise the particle size (e.g., diameter or largest dimension) described above. For example, an average particle size (or the average diameter or the average largest dimension) or a median particle size (or the median diameter or the median largest dimension) of the silicon particles can be less than about 50 μm, less than about 40 μm, less than about 30 μm, less than about 20 μm, less than about 10 μm, less than about 1 μm, between about 10 nm and about 50 μm, between about 10 nm and about 40 μm, between about 10 nm and about 30 μm, between about 10 nm and about 20 μm, between about 0.1 μm and about 50 μm, between about 0.1 μm and about 40 μm, between about 0.1 μm and about 30 μm, between about 0.1 μm and about 20 μm, between about 0.5 μm and about 50 μm, between about 0.5 μm and about 40 μm, between about 0.5 μm and about 30 μm, between about 0.5 μm and about 20 μm, between about 1 μm and about 50 μm, between about 1 μm and about 40 μm, between about 1 μm and about 30 μm, between about 1 μm and about 20 μm, between about 1 μm and about 15 μm, between about 1 μm and about 10 μm, between about 10 nm and about 10 μm, between about 10 nm and about 1 μm, less than about 500 nm, less than about 100 nm, about 100 nm, etc. In some embodiments, the silicon particles may have a distribution of particle sizes. For example, at least about 95%, at least about 90%, at least about 85%, at least about 80%, at least about 70%, or at least about 60% of the particles may have the particle size described herein.

With respect to block 220, the method can include exposing the electrode material to an SEI enhancement precursor of an SEI enhancement compound and/or to an SEI enhancement compound (e.g., to a solution comprising the precursor and/or the compound). In some embodiments, exposing the electrode material can include coating the electrode material. In some embodiments, coating the electrode material can be performed by dipping/submersion, roll form coating, a continuous dip coating, gravure coating, slot die coating, reverse comma coating, or doctor blading. In various embodiments, the electrode material can be exposed to a solution comprising the SEI enhancement precursor and/or the SEI enhancement compound. In some embodiments, the method can also include exposing the electrode material to acidic conditions. Exposing the electrode material to the SEI enhancement precursor and exposing the electrode material to acidic conditions can occur concurrently or sequentially. In some embodiments, the method can comprise exposing the electrode material to a SEI enhancement precursor in acidic conditions (e.g., to a solution comprising the precursor in acidic conditions). For example, the SEI enhancement precursor can be exposed to acidic conditions, and subsequently the electrode material can be exposed to the SEI enhancement precursor in acidic conditions. As another example, the SEI enhancement precursor can be exposed to acidic conditions concurrently with exposing the electrode material with the SEI enhancement precursor. In some embodiments, the method can include exposing the electrode material to an SEI enhancement precursor (e.g., in solution), and subsequently exposing the electrode material and SEI enhancement precursor to acidic conditions. As another example, the method can include exposing the electrode material to the SEI enhancement precursor (e.g., in solution) subsequent to exposing the electrode material to acidic conditions. In some embodiments, exposure to the SEI enhancement precursor can be used to form an SEI enhancement compound. For example, in some instances, the SEI enhancement compound can form when the SEI enhancement precursor reacts with an acidic solution. In some embodiments, the method can comprise exposing an electrode material with the SEI enhancement compound. For example, coating the electrode material can comprise dipping the electrode material into a solution comprising the SEI enhancement compound. In some embodiments, exposing the electrode material to the SEI enhancement compound and exposing the electrode material to acidic conditions can occur concurrently or sequentially. In some embodiments, the method can include exposing the electrode material to the SEI enhancement compound in acidic conditions (e.g., to a solution comprising the SEI enhancement compound in acidic conditions). In some embodiments, the method can include exposing the electrode material to an SEI enhancement compound (e.g., in solution), and subsequently exposing the electrode material and SEI enhancement compound to acidic condition. In some embodiments, the method can include exposing the electrode material to the SEI enhancement compound (e.g., in solution) subsequent to exposing the electrode material to acidic conditions.

With respect to block 230, the method 200 can include forming an artificial SEI layer on the electrode material from the SEI enhancement precursor and/or the SEI enhancement compound. In some embodiments, the artificial SEI layer comprises nanoparticles of the SEI enhancement compound on the electrode material. In some embodiments, the artificial SEI layer comprises a film of the SEI enhancement compound on the electrode material.

In some instances, block 230 can occur subsequent to block 220. For example, in some embodiments, the electrode material can be exposed to the SEI enhancement precursor, and subsequently, when exposed to acidic conditions, the SEI enhancement compound may coat and form on the electrode material. In some instances, blocks 220 and 230 can occur concurrently. For example, in some embodiments, as the electrode material is exposed to the SEI enhancement precursor in acidic conditions, an SEI enhancement compound may form on the electrode material. As another example, in some embodiments, as the electrode material is exposed to the SEI enhancement compound, the SEI enhancement compound can coat the electrode material.

In some embodiments, the method can comprise forming nanoparticles of the SEI enhancement compound on the electrode material. In some embodiments, the method can comprise forming a thin film of the SEI enhancement compound on the electrode material. The layer can be about 1 nm to about 20 nm thick (e.g., about 1 nm to about 15 nm, about 1 nm to about 10 nm, about 3 nm to about 20 nm, about 3 nm to about 15 nm, about 3 nm to about 10 nm, about 4 nm to about 20 nm, about 4 nm to about 15 nm, about 4 nm to about 10 nm, about 5 nm to about 20 nm, about 5 nm to about 15 nm, about 5 nm to about 10 nm, etc.).

In some embodiments, the SEI enhancement precursor can comprise a silicon oxide precursor, a metal oxide precursor, a metal nitride precursor, a metal oxynitride precursor, a metal phosphide precursor, or a combination thereof. In some embodiments, the silicon oxide precursor can comprise tetraethyl orthosilicate (TEOS), trimethoxysilane (TMOS), methyltriethoxysilane (MTES), or a combination thereof.

In various embodiments, the weight ratio of the SEI enhancement precursor to the electrode material can be in the range of about 1:1 to about 1:20. For example, the weight ratio can be about 1:2.5 to about 1:15 or about 1:5 to about 1:10. In some embodiments, the weight ratio can be about 1:5. In some embodiments, the weight ratio can be about 1:10.

In some embodiments, the SEI enhancement compound can comprise a silicon oxide compound, a metal oxide compound, a metal nitride compound, a metal oxynitride compound, a metal phosphide compound, or a combination thereof. In some embodiments, the silicon oxide compound can comprise SiO₂.

In some embodiments, the metal oxide compound can comprise Al₂O₃, TiO₂, CuO, ZnO, SnO₂, Nb₂O₅, RuO₂, IrO₂, TiNb₂O₇, ZnₓFe_{y}O_{z}, M-LiₓO wherein M is a transition metal, or a combination thereof. In some embodiments, the metal oxide compound can be a compound with excellent electrochemical activity, ionic conductivity, and elasticity. These thin metal oxide coatings may function as an artificial SEI, helping inhibit SEI film formation from electrolyte solutions on the surface of Si electrode. The artificial SEI may help inhibit the formation of Li₂CO₃ and LiF, and other organic SEI components, reducing and/or preventing irreversible consumption of Li-ions during cycling. Additionally, the addition of thin coatings may improve the mechanical integrity of the Si core itself by reducing and/or constraining volume expansion and reducing stress concentration.

In some embodiments, the metal nitride compound can comprise TiN, Ni₃N, Ti₂N, NbN, Nb₄N₅, Mn₃N₂, Fe₂N, CoN, CrN, MoN, MoN₂, WN, Sb₃N, Zn₃N₂, Ge₃N₄, Ti₍₁₋ₓ₎NbₓN, SnNₓ, VN, or a combination thereof. These transition metal nitrides can have high chemical stability, such as high resistance against corrosion, high melting points, microhardness, high density and low electrical resistance. In addition, their structures and bonding can help enable them to exhibit high electrical conductivity. As such, a transition metal nitride coating layer may help suppress the drastic volume change of Si powders, provide more stable support and better conductive pathways to Si electrodes and reduce the high volume expansion of high capacity Si-dominant electrode, e.g., in Li-ion batteries.

In some embodiments, the metal oxynitride compound can comprise MoOₓN_{y}, TiOₓN_{y}, N—MoO₃ₓ, or a combination thereof, wherein x≤1 in N—MoO₃ₓ. Transition metal oxynitrides typically possess oxygen vacant sites with surface defects. As such, transition metal oxynitrides may help enhance conductivity, leading to impressive performance for Si-dominant electrode, e.g., in Li-ion batteries.

In some embodiments, the metal phosphide compound can comprise TiP, Ni₅P₄, NiP₃, NiP₂, Sn₄P₃, MnP, FeP, Cu₃P, or a combination thereof. These materials can be considered as alternative electrode active materials for Li-ion battery due to their high gravimetric and volumetric capacities, relatively low charge-discharge potential, good metallic character, and excellent thermal stability.

In some embodiments, the method can further comprise forming the electrode material into the electrode. The electrodes prepared by the methods described may be used in a number of electrochemical devices. In some embodiments, the electrode can comprise a silicon-containing electrode. For example, the electrode can include from greater than 0% to about 100% by weight of silicon. For example, the amount of silicon by weight of the electrode can include any weight percent within this range (e.g., about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99%, about 100%, etc.), or any range within this range such as any range formed by the example values (e.g., greater than about 0% to about 25% by weight, greater than about 0% to about 35% by weight, greater than about 0% to about 50% by weight, greater than about 0% to about 70% by weight, greater than about 0% to about 90% by weight, greater than about 0% to about 95% by weight, greater than about 0% to about 99% by weight, from about 10% to about 35% by weight, from about 10% to about 50% by weight, from about 10% to about 90% by weight, from about 10% to about 95% by weight, from about 10% to about 99% by weight, from about 10% to about 100% by weight, from about 30% to about 85% by weight, from about 30% to about 90% by weight, from about 30% to about 95% by weight, from about 30% to about 99% by weight, from about 30% to about 100% by weight, from about 50% to about 85% by weight, from about 50% to about 90% by weight, from about 50% to about 95% by weight, from about 50% to about 99% by weight, from about 50% to about 100% by weight, from about 60% to about 85% by weight, from about 60% to about 90% by weight, from about 60% to about 95% by weight, from about 60% to about 99% by weight, from about 60% to about 100% by weight, from about 70% to about 85% by weight, from about 70% to about 90% by weight, from about 70% to about 95% by weight, from about 70% to about 99% by weight, from about 70% to about 100% by weight, from about 80% to about 90% by weight, from about 80% to about 95% by weight, from about 80% to about 99% by weight, from about 80% to about 100% by weight, etc.).

In some such instances, the electrode can include a silicon-dominant electrode. For example, the electrode can include silicon-dominant electrochemically active material. As an example, the electrochemically active material can include at least about 50% to about 95% by weight of silicon, at least about 50% to about 99% by weight of silicon, at least about 50% to about 100% by weight of silicon, at least about 60% to about 95% by weight of silicon, at least about 60% to about 99% by weight of silicon, at least about 60% to about 100% by weight of silicon, at least about 70% to about 95% by weight of silicon, at least about 70% to about 99% by weight of silicon, at least about 70% to about 100% by weight of silicon, at least about 80% to about 95% by weight of silicon, at least about 80% to about 99% by weight of silicon, at least about 80% to about 100% by weight of silicon. In some examples, the electrochemically active material can include 100% silicon.

In some instances, the electrode can include the modified silicon powders coated on a current collector. For example, the modified silicon powders can be coated on a current collector with a binder. For instance, the powders can be added to a slurry and coated on a current collector. Additional conductive particles (e.g., graphite) can also be added to the slurry.

In some embodiment, the electrode material can be formed into a film-based electrode. For example, the electrode material can be formed into silicon-carbon composite films fabricated through using the silicon material and carbonized polymer (e.g., a hard carbon). The film-based electrodes may be self-supported structures or attached to a current collector. When attached to a current collector, an attachment substance can be applied using a solution (e.g., a wet process) or applied as in a substantially solid state (e.g., a substantially dry process). In some embodiments, the electrode can comprise graphite. In some embodiments, the electrode can comprise glass carbon (e.g., a hard carbon prepared from carbonization of a polymer). The current collector can be any known in the art or yet to be developed. In some instances, the current collector can comprise a Cu or Ni foil.

In some embodiments, instead of the electrode material being silicon powder/particles, the electrode material can be an electrode, e.g., an electrode coupon. For example, an electrode can be exposed to an SEI enhancement precursor and/or SEI enhancement compound (e.g., in solution), and an artificial SEI layer can form on the electrode. In some instances, the electrode is a silicon-containing electrode. In some instances, the electrode is a silicon-dominant electrode (e.g., comprising silicon-dominant electrochemically active material).

In some embodiments, the electrodes can be used in any electrochemical device known in the art or yet to be developed. For example, the electrochemical device can include a first electrode comprising silicon and an artificial SEI layer, a second electrode, and an electrolyte. In various instances, the first electrode can include silicon-dominant electrochemically active material. In some instances, the artificial SEI layer can comprise nanoparticles of an SEI enhancement compound. In some instances, the artificial SEI layer can comprise a film of an SEI enhancement compound. The first electrode can comprise an anode. The second electrode can comprise a cathode comprising a cathode ion. In some embodiments, the cathode ion can include Li, Na, K, or mixtures thereof. In some embodiments, the cathode ion can comprise Li. In some embodiments, the cathode ion can be Li. In some embodiments, the cathode can comprise lithium cobalt oxide (LiCoO₂) (LCO). In some embodiments, the cathode can comprise about 97 wt % LiCoO₂. In some embodiments, the cathode can be a film-based electrode. In some embodiments, the cathode can be a layered Nickel-Cobalt-Manganese (NCM) or Nickel-Cobalt-Aluminum (NCA) cathode. In some embodiments, the cathode can include a lithium rich oxide, a nickel-rich oxide, a high-voltage cathode material, a lithium rich layered oxide, a nickel-rich layered oxide, a high-voltage spinel oxide, and/or a high-voltage polyanionic compound. Lithium rich oxides may include xLi₂MnO₃.(1−x)LiNiₐCo_{b}Mn_{c}O₂. Nickel-rich layered oxides may include LiNi₁₋ₓMₓO₂, where M comprises Co, Mn, or Al). Lithium rich layered oxides may include LiNi₁₊ₓM₁₋ₓO₂, where M comprises Co, Mn, or Ni). High-voltage spinel oxides may include LiNi_{0.5}Mn_{1.5}O₄. High-voltage polyanionic compounds may include phosphates, sulfates, silicates, etc. In some instances, high-voltage may refer to at least 4.7V, 5V, etc. In some embodiments, the cathode can comprise carbon black (e.g., Super P). In some embodiments, the cathode can comprise a binder (e.g., PVDF5130). In some embodiments, the cathode can comprise a current collector (e.g., Al foil). As an example, the cathode active material can be mixed with carbon black and binder to prepare a slurry. The slurry can be coated on the surface of the current collector. The solvent can be dried from the coated current collector to form a cathode. Other examples are possible.

In some embodiments, the electrochemical device can comprise any electrolyte known in the art or yet to be developed. In some embodiments, the electrolyte can comprise fluoroethylene carbonate (FEC), ethyl methyl carbonate (EMC), dimethyl carbonate (DMC), diethyl carbonate (DEC), propylene carbonate (often abbreviated PC), other partially or fully fluorinated linear or cyclic carbonates, or mixtures thereof. In some embodiments, the electrolyte can comprise FEC or EMC, or mixtures thereof. In some embodiments, the electrolyte can comprise greater than or equal to about 10 wt % FEC, EMC, DMC, DEC, PC or others, or mixtures thereof. In some embodiments, the electrolyte can comprise greater than or equal to about 10 wt % FEC or EMC, etc., or mixtures thereof. In some embodiments, the electrolyte can comprise about 30 wt % FEC, about 35 wt % DEC and about 35 wt % EMC. In some embodiments, the electrolyte can comprise about 30 wt % FEC and about 70 wt % EMC. In some embodiments, the electrolyte may or may not comprise ethylene carbonate (EC). In some embodiments, the electrolyte can comprise LiPF₆. In some embodiments, the electrolyte can comprise LiPF₆ at a concentration of about 1 M, 1.2 M, or any concentration between 1 M and 1.2 M. In addition, the LiPF₆ salt can be mixed together with a certain amounts of other Li salts, such as lithium hexafluorophosphate (LiPF₆), lithium tetrafluoroborate (LiBF₄), lithium hexafluoroarsenate monohydrate (LiAsF₆), lithium bis(trifluoromethanesulfonyl)imide (LiTFSI), lithium bis(fluorosulfonyl)imide (LiFSI), lithium difluoro(oxalate)borate (LiDFOB), and lithium triflate (LiCF₃SO₃), lithium tetrafluorooxalato phosphate (LTFOP), lithium difluorophosphate (LiPO₂F₂), lithium pentafluoroethyltrifluoroborate (LiFAB), lithium 2-trifluoromethyl-4,5-dicyanoimidazole (LiTDI), etc. In some embodiments, the electrolyte can comprise some additives, including any of the above-mentioned Li salt-based additives.

In some embodiments, the electrochemical device can be a battery, e.g., a Li-ion battery.

### Examples

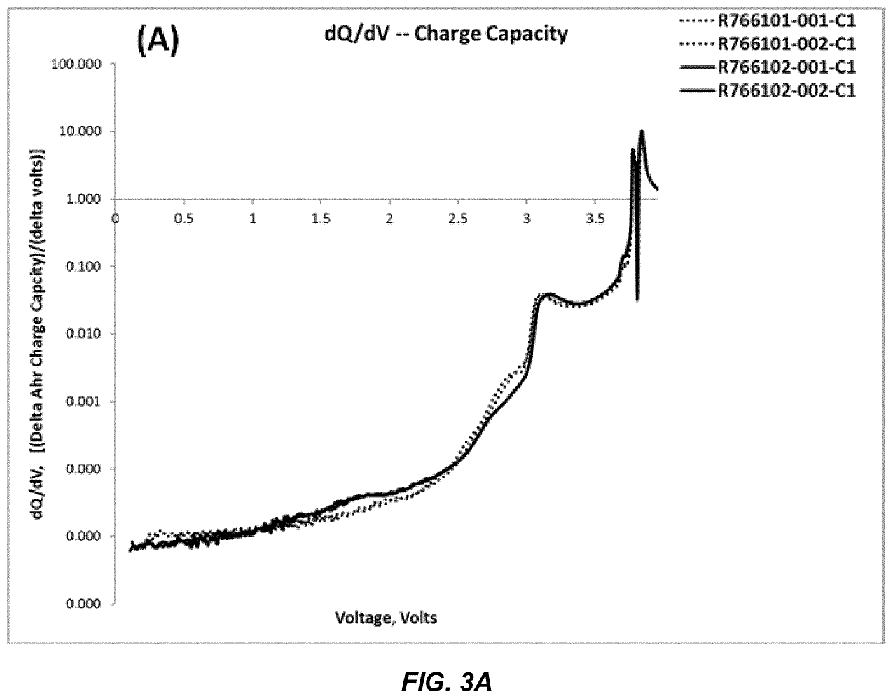

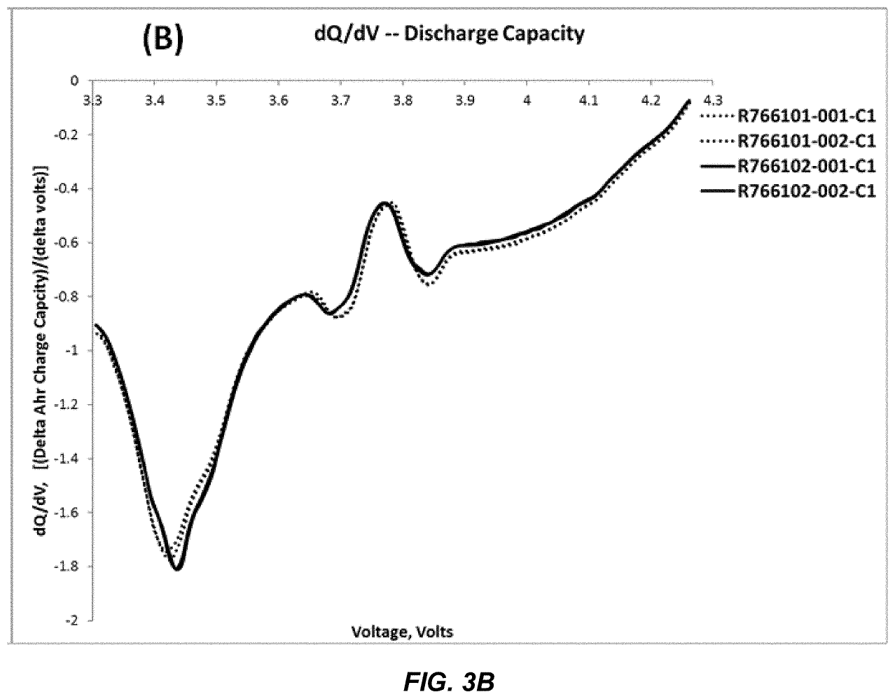

FIGS. 3A-10B demonstrate tests of 1.2M LiPF₆ in FEC/EMC (3/7 wt %) electrolytes and evaluation of their electrochemical performance in silicon-dominant anode//LiCoO₂ cathode full cells, wherein the silicon-dominant anodes are prepared with SiO₂-coated Si powders from a TEOS/Si=1/10 solution and a TEOS/Si=1/5 solution. The electrochemical tests were carried out at 1 C/0.5 C charge/discharge processes with the working voltage of 4.3V-3.3 V.

The charge capacity (dQ/dV) data for control and TEOS/Si (e.g., TEOS/Si=1/10 and TEOS/Si=1/5) processed cells were obtained through the following testing protocol: Rest 5 minutes, charge at 0.025 C to 25% nominal capacity, charge at 0.2 C to 4.3 V until 0.05 C, rest 5 minutes, discharge at 0.2 C to 3.3 V, rest 5 minutes.

The long-term cycling for control and TEOS/Si (e.g., TEOS/Si=1/10 and TEOS/Si=1/5) processed cells include: (i) At the 1^{st} cycle, charge at 0.5 C to 4.3 V for 5 hours, rest 5 minutes, 1 ms internal resistance (IR), 100 ms IR, discharge at 0.2 C to 2.75 V, rest 5 minutes, 1 ms IR, 100 ms IR; and (ii) from the 2^{nd} cycle, charge at 1 C to 4.3 V until 0.05 C, rest 5 minutes, 1 ms IR, 100 ms IR, discharge at 0.5 to 3.3 V, rest 5 minutes, 1 ms IR, 100 ms IR. After each 49 cycles, the test conditions in the 1^{st} cycle were repeated.

In addition, control and TEOS/Si (e.g., TEOS/Si=1/10 and TEOS/Si=1/5) processed cells were formatted for 6 cycles at the following conditions before long-term cycling: (i) At the 1^{st} cycle, Rest 5 minutes, charge at 0.025 C to 25% nominal capacity, charge at 0.2 C to 4.3 V until 0.05 C, rest 5 minutes, discharge at 0.2 C to 3.3 V, rest 5 minutes; and (ii) from 2^{nd} to 6^{th} cycles, charge at 0.5 C to 4.3 V until 0.05 C, rest 5 minutes, discharge at 0.5 C to 3.3 V, rest 5 minutes.

The Resistance (Res) fields are values that were calculated using data points of voltage and current. The method linearly interpolated for a voltage at 10 s or 30 s in the charge/discharge step between the two data points before and after that time. Then, the method took the difference between that voltage and the last voltage during rest when current is 0 and divided it by the charge or discharge current. Res_10s_C were calculated using discharge data (for the charged state). Res_10s_DC were calculated using charge data (for the cell state at the beginning of the cycle). Res_30s_C was calculated using discharge data (for the charged state). Res_30s_DC was calculated using charge data (for the cell state at the beginning of the cycle).

### Synthesis of SiO₂ Coated Si Powders (TEOS/Si=1/5)

SiO₂-coated Si powders were prepared from a TEOS/Si=1 wt %/5 wt % solution as follows. 300 g of Si powders were diluted with 300 g of water and 1200 g of substantially pure ethanol. The pH of the Si powder dispersion was adjusted to 2.5 by adding about 200 ml of 0.1 mol/L HCl solution and then the reaction mixture was slowly heated to 60° C., followed by slow addition (5 g/h) of the mixed solution containing 200 g ethanol and 60 g TEOS. SiO₂ coated Si powders were obtained after the reaction was performed for 12 h under constant stirring. The samples were then moved out from the reactive container and dried at 80° C. overnight. The SiO₂ coated Si powder was subsequently used to prepare SiO₂ coated Si dominant anodes for Li-ion batteries.

### Synthesis of SiO₂ Coated Si Powders (TEOS/Si=1/10)

SiO₂-coated Si powders were prepared from a TEOS/Si=1 wt %/10 wt % solution as follows. 300 g of Si powder was diluted with 300 g of water and 1200 g of substantially pure ethanol. The pH of the Si powder dispersion was adjusted to 2.5 by adding about 200 ml of 0.1 mol/L HCl and then the reaction mixture was slowly heated to 60° C., followed by slow addition (5 g/h) of the mixed solution containing 200 g ethanol and 30 g TEOS. SiO₂ coated Si powders were obtained after the reaction was performed for 12 h under constant stirring. The samples were then moved out from the reactive container and dried at 80° C. overnight. The SiO₂ coated Si powder was subsequently used to prepare SiO₂ coated Si dominant anodes for Li-ion batteries.

### Results Using SiO₂ Coated Si Powders (TEOS/Si=1/10)

FIG. 3A demonstrates the charge capacity as a function of voltage and FIG. 3B demonstrates the discharge capacity as a function of voltage of a control battery (shown as a dotted line), and a battery with an anode prepared from a TEOS/Si=1 wt %/10 wt % solution (shown as a solid line). The 1^{st} formation cycle dQ/dV curves in FIGS. 3A-3B demonstrate that the battery with an anode prepared from a TEOS/Si=1 wt %/10 wt % solution show a reduction peak at around 2.75 V (due to the reduction of FEC) that is still present in SiO₂ coated Si-dominant anode-based system. This indicates that the SiO₂ coating has little negative influence on the initial electrolyte solvent (FEC) reduction and forms an SEI film on the surface of the Si anode.

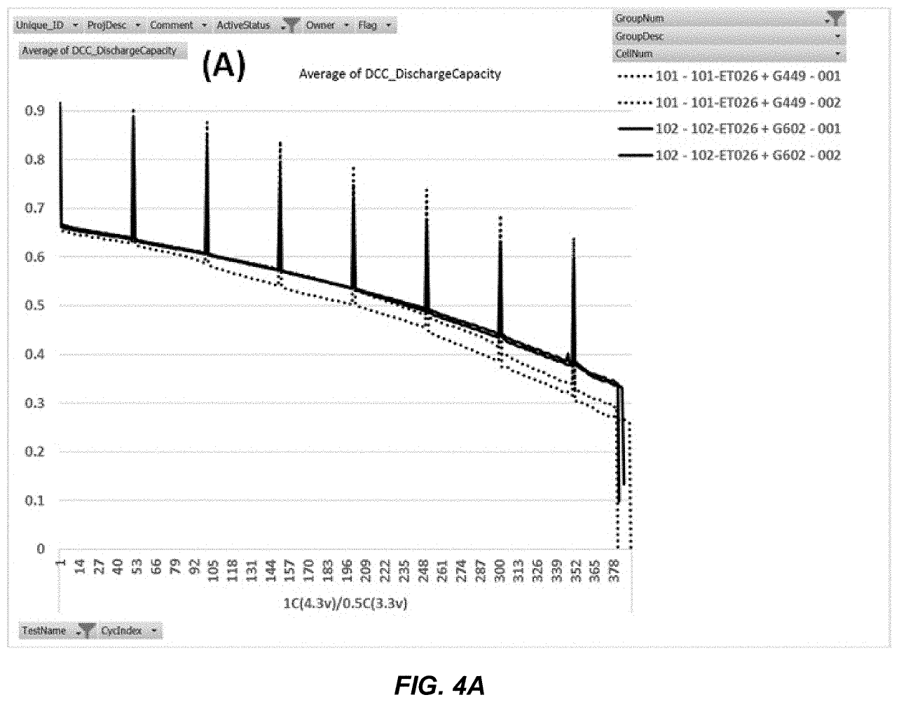

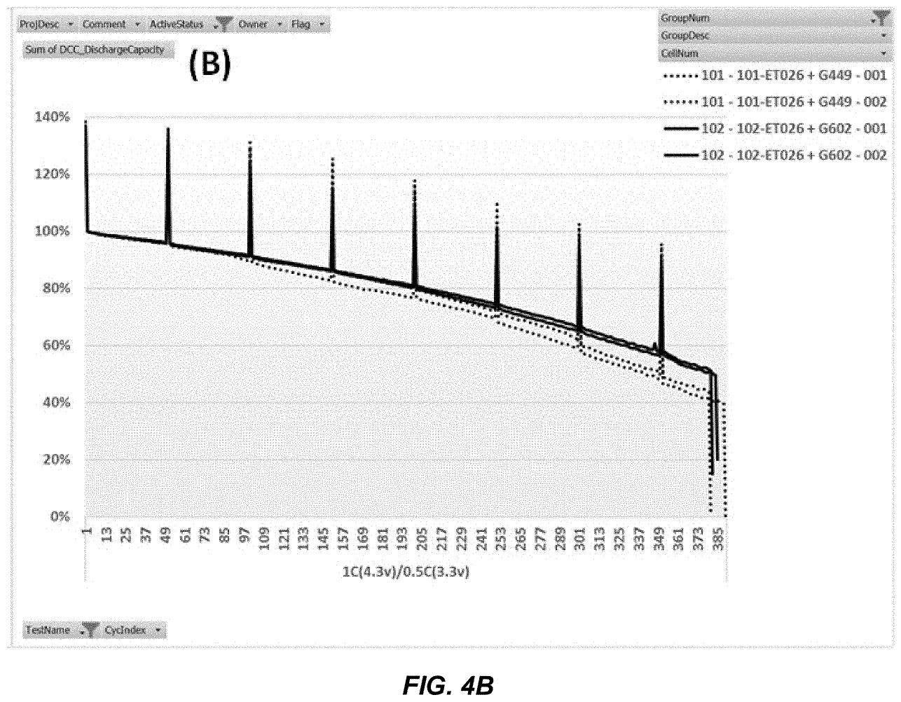

FIG. 4A demonstrates the capacity as a function of cycles and FIG. 4B demonstrates the capacity retention as a function of cycles of a control battery (shown as a dotted line), and a battery with an anode prepared from a TEOS/Si=1 wt %/10 wt % solution (shown as a solid line). The results of FIGS. 4A-4B demonstrate that a battery with an anode prepared from a TEOS/Si=1 wt %/10 wt % solution improves capacity and capacity retention after about 200 cycles.

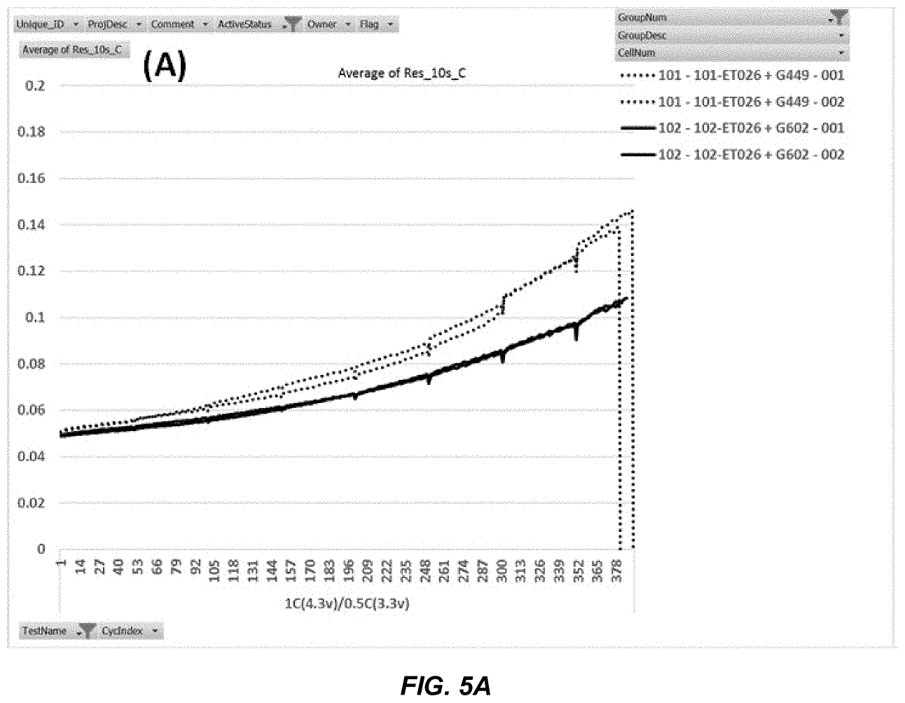

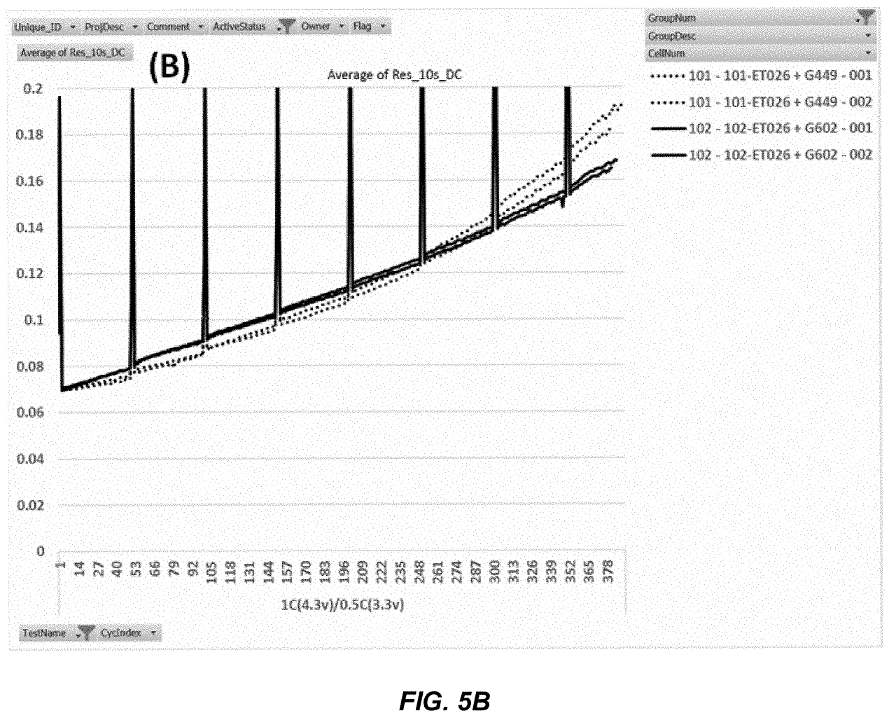

FIG. 5A demonstrates the average resistance as a function of cycles after 10 s charge and FIG. 5B demonstrates the average resistance as a function of cycles after 10 s discharge of a control battery (shown as a dotted line), a battery with an anode prepared from a TEOS/Si=1 wt %/10 wt % solution (shown as a solid line). The results of FIGS. 5A-5B demonstrate that the anode prepared from a TEOS/Si=1 wt %/10 wt % solution has lower average resistance after a 10 s charge/discharge processes than control devices after about 250 cycles.

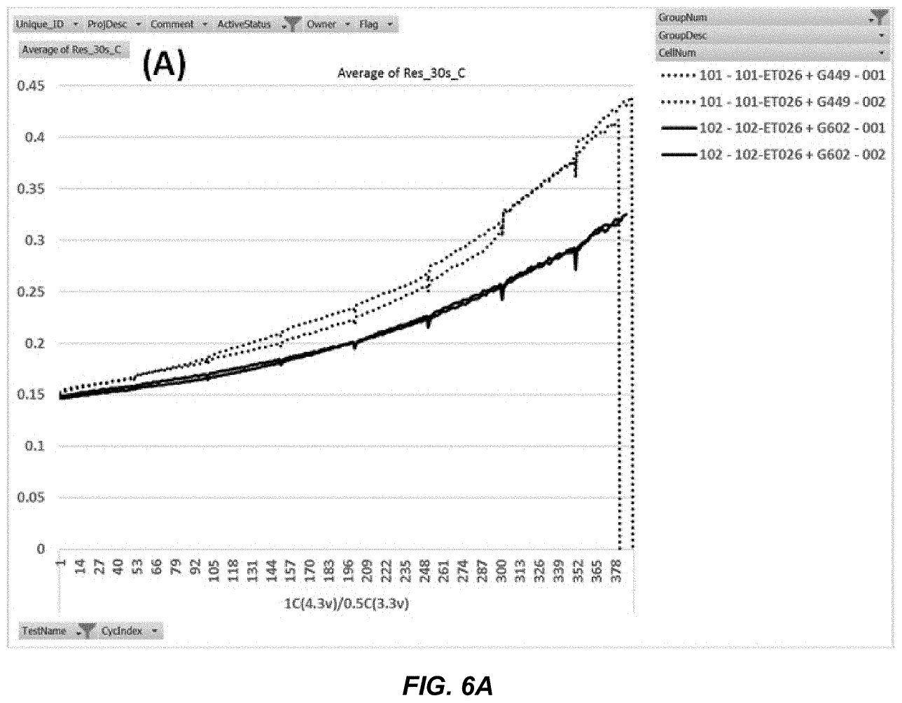

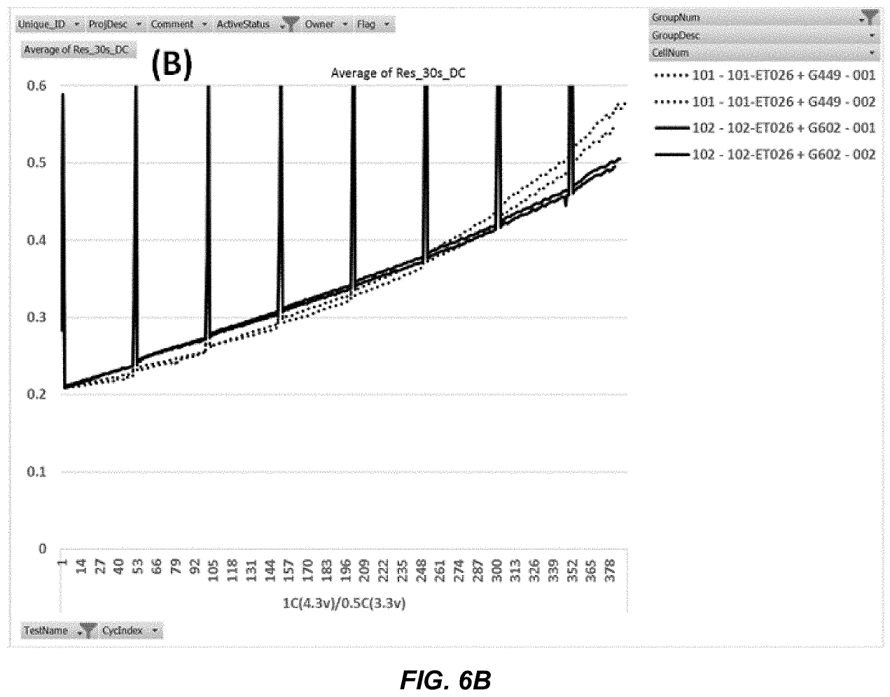

FIG. 6A demonstrates the average resistance as a function of cycles after 30 s charge and FIG. 6B demonstrates the average resistance as a function of cycles after 30 s discharge processes of a control battery (shown as a dotted line), a battery with an anode prepared from a TEOS/Si=1 wt %/10 wt % solution (shown as a solid line). The results of FIGS. 6A-6B demonstrate that an anode prepared from a TEOS/Si=1 wt %/10 wt % solution has lower average resistance after a 30 s charge/discharge processes than control devices after about 250 cycles.

### Results Using SiO₂ Coated Si Powders (TEOS/Si=1/5)

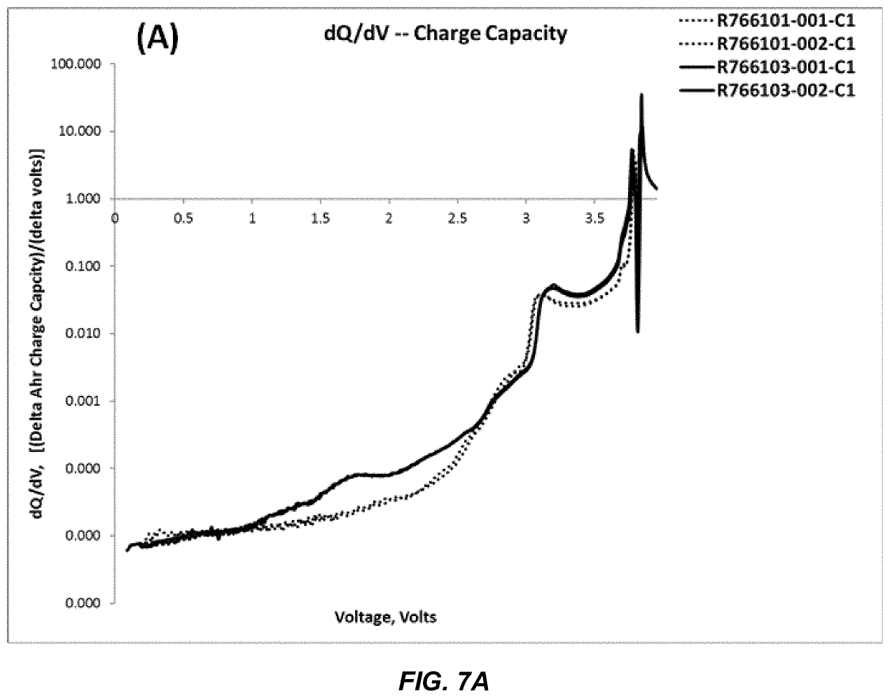

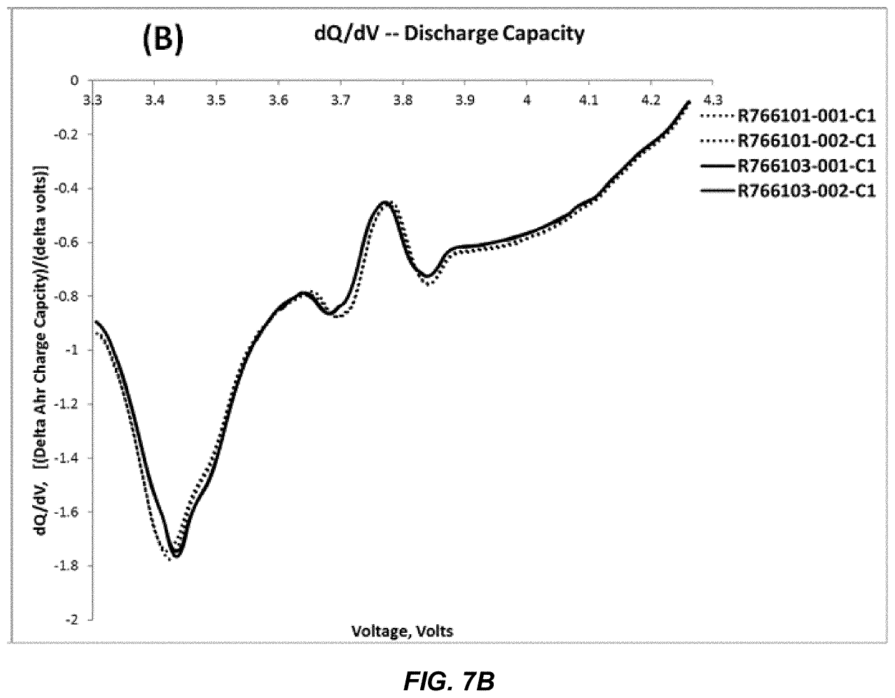

FIG. 7A demonstrates the charge capacity as a function of voltage and FIG. 7B demonstrates the discharge capacity as a function of voltage of a control battery (shown as a dotted line), and a battery with an anode prepared from a TEOS/Si=1 wt %/5 wt % solution (shown as a solid line). The 1^{st} formation cycle dQ/dV curves in FIGS. 7A-7B demonstrate that the battery with an anode prepared from a TEOS/Si=1 wt %/5 wt % solution show a reduction peak at around 2.75 V (due to the reduction of FEC) that is still present in SiO₂ coated Si-dominant anode-based system. This indicates that the SiO₂ coating has little negative influence on the initial electrolyte solvent reduction on the surface of the Si anode.

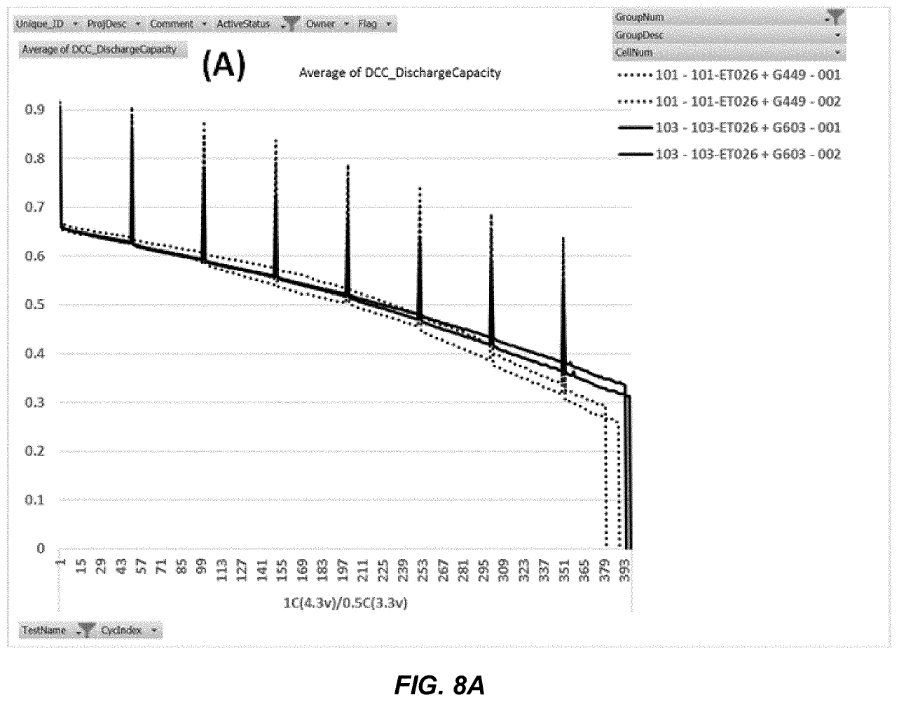

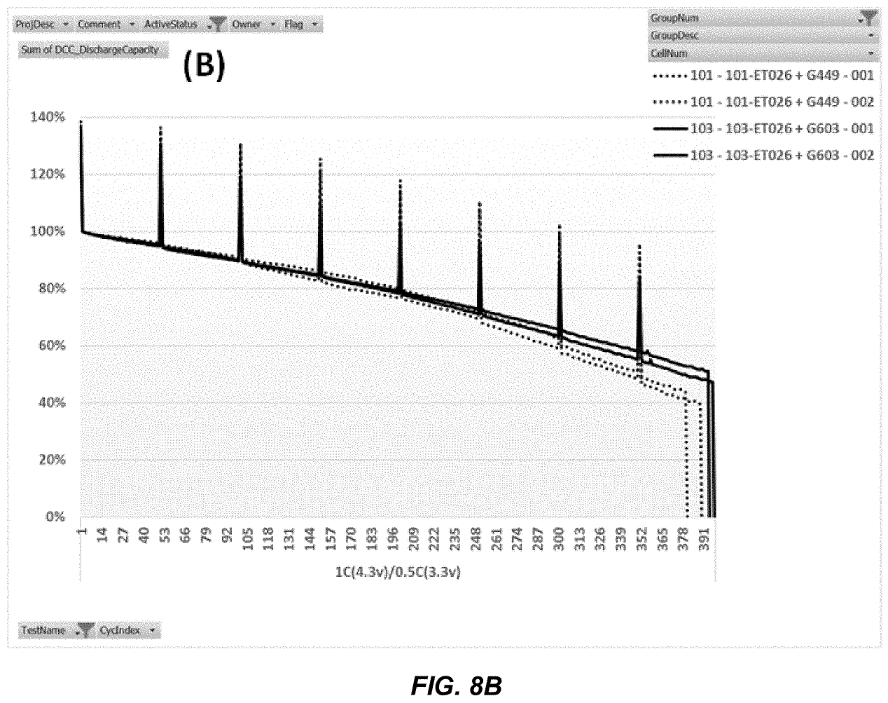

FIG. 8A demonstrates the capacity as a function of cycles and FIG. 8B demonstrates the capacity retention as a function of cycles of a control battery (shown as a dotted line), and a battery with an anode prepared from a TEOS/Si=1 wt %/5 wt % solution (shown as a solid line). The results of FIGS. 8A-8B demonstrate that a battery with an anode prepared from a TEOS/Si=1 wt %/5 wt % solution improves capacity and capacity retention after about 200 cycles.

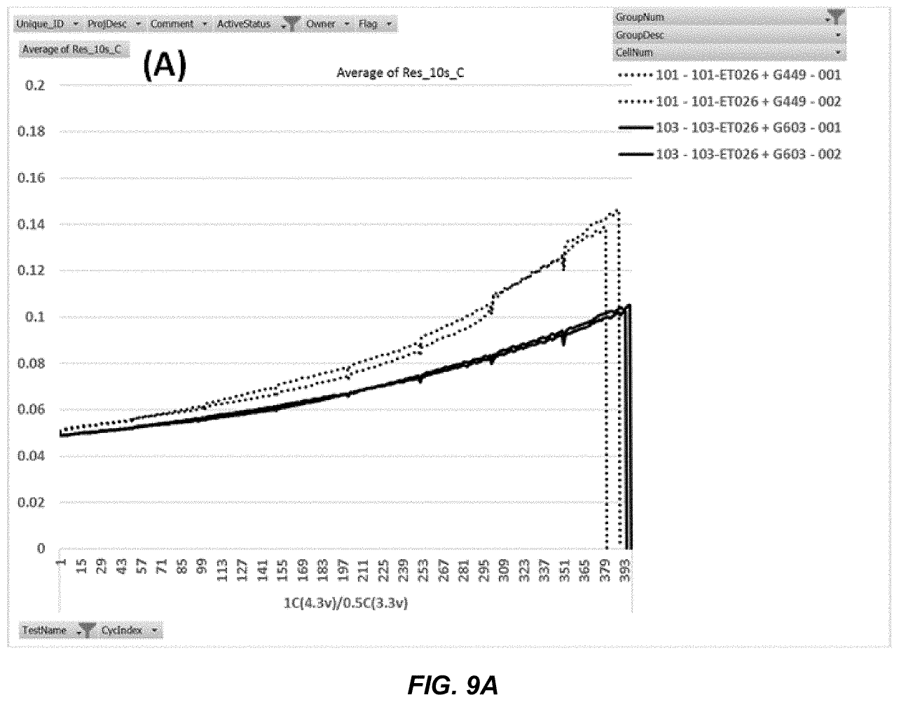

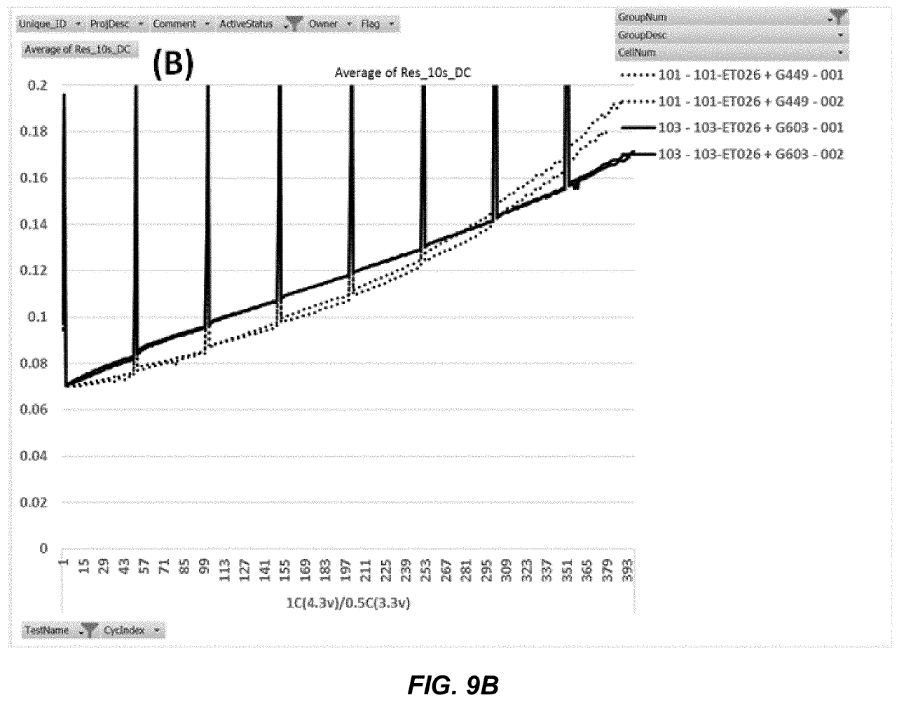

FIG. 9A demonstrates the average resistance as a function of cycles after 10 s charge and FIG. 9B demonstrates the average resistance as a function of cycles after 10 s discharge processes of a control battery (shown as a dotted line), a battery with an anode prepared from a TEOS/Si=1 wt %/5 wt % solution (shown as a solid line). The results of FIGS. 9A-9B demonstrate that the anode prepared from a TEOS/Si=1 wt %/5 wt % solution has lower average resistance after a 10 s charge/discharge processes than control devices after about 300 cycles.

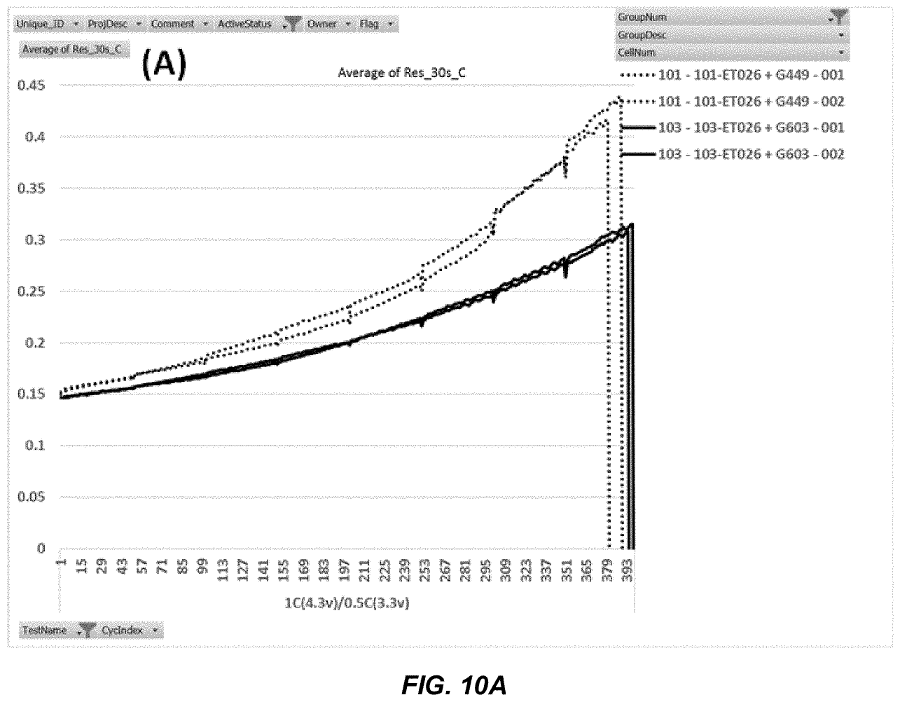

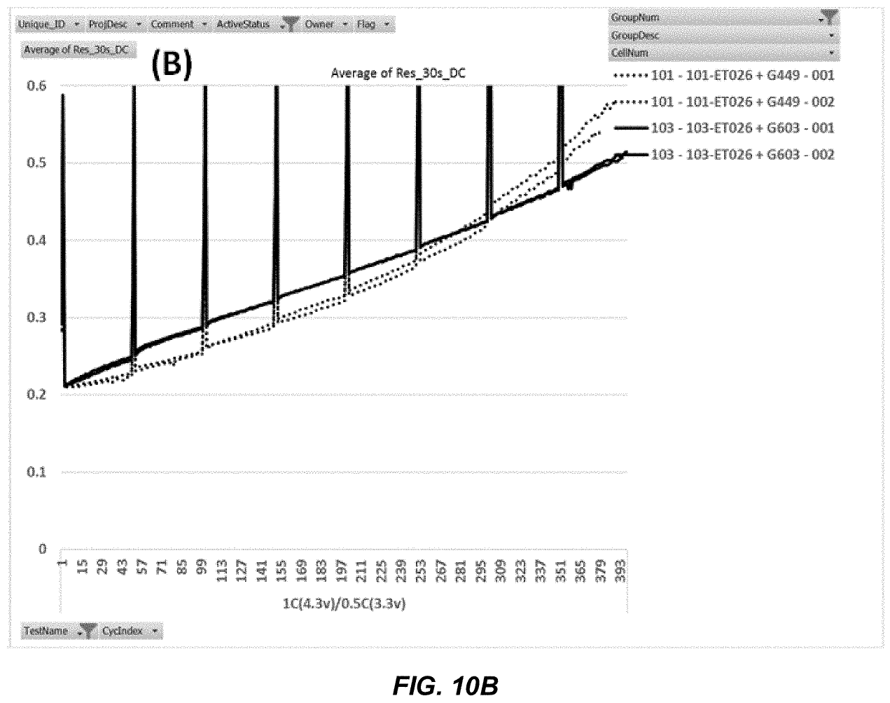

FIG. 10A demonstrates the average resistance after 30 s charge and FIG. 10B demonstrates the average resistance after 30 s discharge processes of a control battery (shown as a dotted line), a battery with an anode prepared from a TEOS/Si=1 wt %/5 wt % solution (shown as a solid line). The results of FIGS. 10A-10B demonstrate that an anode prepared from a TEOS/Si=1 wt %/5 wt % solution has lower average resistance after a 30 s charge/discharge processes than control devices after about 300 cycles.

### Dip Coating in SiO₂ Solution:

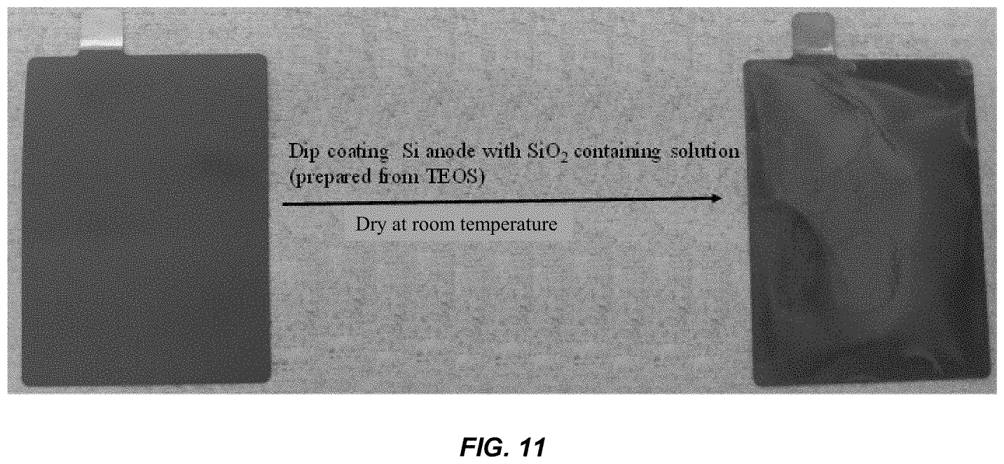

FIG. 11 demonstrates a Si-dominant anode dip coated in a SiO₂ solution prepared from TEOS. This dip coating process is used to first form SiO₂ particles in solution, and then to coat the electrode with SiO₂ particles directly on the surface of the Si anode followed by drying at room temperature and at 120° C. before building 5-layer pouch cells.

### Dip Coating in TEOS Alcohol Solution, Followed by Adding Acidic Solution

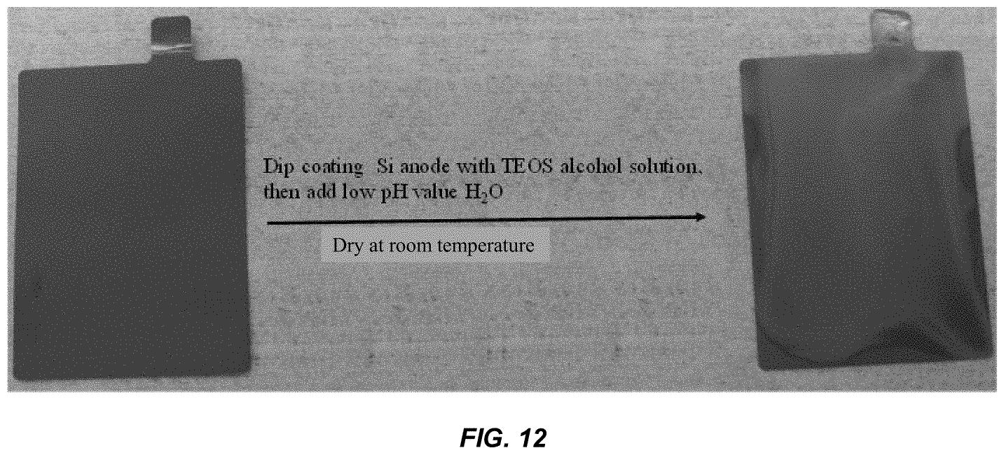

FIG. 12 demonstrates a Si-dominant anode dip coated in a TEOS alcohol solution, then subsequently a low pH aqueous solution was added to transfer soaked TEOS into SiO₂. This dip coating then acid application process is used to coat the electrode with a SiO₂ precursor, and then to precipitate SiO₂ particles on the electrode followed by drying at room temperature and at 120° C. before building 5-layer pouch cells.

1. A method of preparing an electrode comprising:
providing an electrode material comprising silicon;
exposing the electrode material to a solution, wherein the solution comprises a solid electrolyte interphase (SEI) enhancement precursor of an SEI enhancement compound and/or the solution comprises the SEI enhancement compound;
exposing the electrode material to acidic conditions; and
forming an artificial SEI layer comprising the SEI enhancement compound on the electrode material from the SEI enhancement precursor and/or the SEI enhancement compound.

2. The method of claim 1, further comprising forming the electrode material into the electrode.

3. The method of claim 2, wherein the electrode is an anode.

4. The method of claim 2, wherein the electrode material comprises the silicon as Si particles.

5. The method of claim 2, wherein the Si particles have an average particle size between 1 μm and 50 μm.

6. The method of claim 2, wherein the electrode comprises Si dominant electrochemically active material.

7. The method of claim 6, wherein the electrochemically active material comprises the silicon at about 70% to about 100% by weight.

8. The method of claim 1, wherein the electrode material comprises the electrode.

9. The method of claim 8, wherein the electrode is an anode.

10. The method of claim 8, wherein the electrode comprises Si dominant electrochemically active material.

11. The method of claim 10, wherein the electrochemically active material comprises the silicon at about 70% to about 100% by weight.

12. The method of claim 1, wherein exposing the electrode material to the solution and exposing the electrode material to acidic conditions occur concurrently by exposing the electrode material to the solution comprising the SEI enhancement precursor in acidic conditions.

13. The method of claim 1, wherein exposing the electrode material to the solution comprises exposing the electrode material to the solution comprising the SEI enhancement precursor, and subsequently exposing the electrode material to acidic conditions.

14. The method of claim 1, wherein exposing the electrode material to the solution comprises exposing the electrode material to the solution comprising the SEI enhancement precursor subsequent to exposing the electrode material to acidic conditions.

15. The method of claim 1, wherein exposing the electrode material to the solution and exposing the electrode material to acidic conditions occur concurrently by exposing the electrode material to the solution comprising the SEI enhancement compound in acidic conditions.

16. The method of claim 1, wherein exposing the electrode material to the solution comprises exposing the electrode material to the solution comprising the SEI enhancement compound, and subsequently exposing the electrode material to acidic conditions.

17. The method of claim 1, wherein exposing the electrode material to the solution comprises exposing the electrode material to the solution comprising the SEI enhancement compound subsequent to exposing the electrode material to acidic conditions.

18. The method of claim 1, wherein the artificial SEI layer comprises nanoparticles of the SEI enhancement compound on the electrode material.

19. The method of claim 1, wherein the artificial SEI layer comprises a film of the SEI enhancement compound on the electrode material.

20. The method of claim 1, wherein the SEI enhancement precursor comprises a silicon oxide precursor, a metal oxide precursor, a metal nitride precursor, a metal oxynitride precursor, a metal phosphide precursor, or a combination thereof.

21. The method of claim 20, wherein the silicon oxide precursor comprises tetraethyl orthosilicate (TEOS), trimethoxysilane (TMOS), methyltriethoxysilane (MTES), or a combination thereof.

22. The method of claim 1, wherein the SEI enhancement compound comprises a silicon oxide compound, a metal oxide compound, a metal nitride compound, a metal oxynitride compound, a metal phosphide compound, or a combination thereof.

23. The method of claim 22, wherein the silicon oxide compound comprises SiOₓ where 1≤x≤2.

24. The method of claim 22, wherein the metal oxide compound comprises Al₂O₃, TiO₂, CuO, ZnO, SnO₂, Nb₂O, RuO₂, IrO₂, TiNb₂O₇, ZnₓFe_{y}O_{z}, M-LiₓO wherein M is a transition metal, or a combination thereof.

25. The method of claim 22, wherein the metal nitride compound comprises TiN, Ni₃N, Ti₂N, NbN, Nb₄N₅, Mn₃N₂, Fe₂N, CoN, CrN, MoN, MoN₂, WN, Sb₃N, Zn₃N₂, Ge₃N₄, Ti₍₁₋ₓ₎NbₓN, SnNₓ, VN, or a combination thereof.

26. The method of claim 22, wherein the metal oxynitride compound comprises MoOₓN_{y}, TiOₓN_{y}, N—MoO₃ₓ, or a combination thereof, wherein x≤1 for N—MoO₃ₓ.

27. The method of claim 22, wherein the metal phosphide compound comprises TiP, Ni₅P₄, NiP₃, NiP₂, Sn₄P₃, MnP, FeP, Cu₃P, or a combination thereof.

28. The method of claim 1, wherein the weight ratio of the SEI enhancement precursor to the electrode material is about 1:1 to about 1:20.

29. The method of claim 28, wherein the weight ratio of the SEI enhancement precursor to the electrode material is about 1:2.5 to about 1:15.

30. The method of claim 29, wherein the weight ratio of the SEI enhancement precursor to the electrode material is about 1:5 to about 1:10.

31. The method of claim 30, wherein the weight ratio of the SEI enhancement precursor to the electrode material is about 1:5.

32. The method of claim 30, wherein the weight ratio of the SEI enhancement precursor to the electrode material is about 1:10.

33.-58. (canceled)
